(19) United States
(12) Patent Application Publication
(10) Pub. No.: US 2024/0402512 A1
(43) Pub. Date: Dec. 5, 2024

(54) AUGMENTED REALITY EYEWEAR DISPLAYS WITH INSERTABLE PRESCRIPTION LENSES

(71) Applicant: GOOGLE LLC, Mountain View, CA (US)

(72) Inventors: Bach Nguyen, Coral Springs, FL (US); Nabila Zaman, Cambridge (CA); Geoffrey Gudgeon, Waterdown (CA); Joshua Moore, Elora (CA); Charles R. Schabacker, San Jose, CA (US)

(21) Appl. No.: 18/205,339

(22) Filed: Jun. 2, 2023

(51) Int. Cl. G02C 3/00; G02B 27/01; G02C 5/12; G02C 11/00

(52) U.S. Cl. CPC G02C 3/00; G02B 27/0172; G02C 5/126; G02C 11/10; G02B 2027/0178

(57) ABSTRACT

An eyewear display includes a frame comprising two lens rims and a nose bridge, a first lens rim of the two lens rims holding a lens stack including a first lens (e.g., a world-side lens) and a waveguide. A detachable rim piece is attached to the first lens rim, and, upon being detached from the first lens rim, the detachable rim piece exposes a loading cavity housing a lens retention component. The lens retention component is removable from the loading cavity to insert a second lens with a vision correction prescription within the lens stack of the first lens rim. The lens retention component is then re-inserted into the loading cavity to fix the second lens (e.g., an eye-side lens) into the lens stack of the first lens rim. The detachable rim piece is then re-attached to cover the loading cavity and the lens retention component.

### BACKGROUND

Augmented reality (AR) eyewear displays provide a user with an interactive experience that enhances the real world with images generated by the AR eyewear display. In some cases, AR eyewear displays include integrated vision correction prescription lenses (referred to as prescription lenses, or Rx lenses, for short) so a user does not have to wear a separate pair of eyeglasses or contact lenses with the AR eyewear display. In this manner, AR eyewear displays with integrated Rx lenses allow a wider range of users to enjoy an AR experience. Due to the complex nature of AR eyewear displays, conventional techniques for fulfilling different Rx lens types in AR eyewear displays typically fall on the AR eyewear display manufacturer. In some cases, it may be advantageous for parties other than the AR eyewear display manufacturer to fulfill an Rx lens or update the Rx lens in the AR eyewear display to reduce delays in delivering the AR eyewear display to the user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example eyewear display, in accordance with some embodiments.

FIG. 2 illustrates a partially transparent view of an eyewear display, such as the eyewear display of FIG. 1, including a lens stack serving as an optical combiner, in accordance with various embodiments.

FIG. 3 illustrates an example of an exploded view of mechanical components for installing a second lens into an eyewear display, such as the eyewear display of FIGS. 1 and 2, in accordance with various embodiments.

FIG. 4 illustrates an example diagram showing two stages of the second lens insertion process into an eyewear display, such as the eyewear display of FIGS. 1-3, in accordance with various embodiments.

FIG. 5 illustrates an example cross-sectional view of a lens rim, such as one of the lens rims in the eyewear display shown in FIGS. 1-4, in accordance with various embodiments.

FIGS. 6 and 7 illustrate an example perspective view and an example close-up view of a lens rim after the insertion of a second lens and the re-insertion of the retaining clip in an eyewear display, such as the eyewear display of FIGS. 1-5, in accordance with various embodiments.

FIG. 8 illustrates an example flowchart describing a process for inserting a second lens into an eyewear display, such as the eyewear display of FIGS. 1 and 2, with mechanical components, in accordance with various embodiments.

FIG. 9 illustrates an example of an exploded view of adhesive-based components prior to installing a second lens into an eyewear display, such as the eyewear display of FIGS. 1 and 2, in accordance with various embodiments

FIG. 10 illustrates an example of an exploded view of adhesive-based components after inserting the second lens into the eyewear display shown in FIG. 9, in accordance with various embodiments.

FIG. 11 illustrates an example cross-sectional view of a lens rim, such as one of the lens rims in the eyewear display shown in FIGS. 1-2 or in FIG. 10, with adhesive-based components for inserting a second lens, in accordance with various embodiments.

FIG. 12 illustrates an example of semi-exploded cross-section view of a lens rim with an adhesive-based embodiment for inserting a second lens, in accordance with various embodiments.

FIG. 13 illustrates a non-exploded view of FIG. 12, in accordance with various embodiments.

FIG. 14 illustrates an example flowchart describing a process for inserting a second lens into an eyewear display, such as the eyewear display of FIGS. 1 and 2, with adhesive-based components, in accordance with various embodiments.

FIG. 15 illustrates an example cross-sectional view of a lens rim, such as one of the lens rims in the eyewear display shown in FIGS. 1-2 or in FIG. 10, with ultraviolet (UV) curable adhesive-based components for inserting a second lens, in accordance with various embodiments.

FIG. 16 illustrates an example flowchart describing a process for inserting a second lens into an eyewear display, such as the eyewear display of FIGS. 1 and 2, with UV-curable adhesive-based components, in accordance with various embodiments.

### DETAILED DESCRIPTION

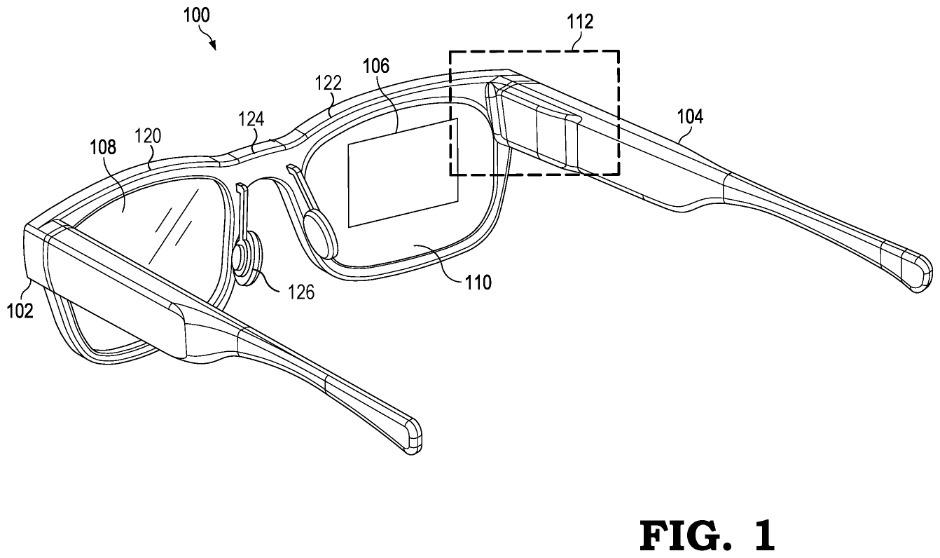

In some cases, AR eyewear displays (referred to as eyewear displays for short) include Rx lenses with curvatures corresponding to a user's vision correction prescription. For example, if a user is near-sighted, the eyewear display includes negative Rx lenses to enable a user to see distant objects more clearly. Or, if a user is far-sighted, the eyewear display includes positive Rx lenses to enable a user to see nearby objects more clearly. Conventionally, the burden of fulfilling this wide range of Rx lens types falls on the eyewear display manufacturer due to the complex design considerations of eyewear displays. For example, in many cases the eyewear display design considerations include maintaining ingress protection (IP) sealing, preserving optical alignment, protecting fragile components, and ensuring that the Rx lens stays in place during drop or high-acceleration events. Furthermore, it is typically desirable for the features that retain the Rx lens and provide the sealing between lens interfaces to be as discreet as possible to minimize the aesthetic impact and bulk added to the eyewear display. In some cases, it may be advantageous to design an eyewear display to enable other parties (e.g., an optometrist) to insert an Rx lens. FIGS. 1-16 provide techniques that enable a party other than the eyewear display manufacturer to fulfill a user's Rx lens type. Thus, the burden to fulfill a wide range of Rx lens types in an eyewear display is shifted away from the eyewear display manufacturer, thereby allowing users requiring Rx lenses to enjoy the AR experience with reduced or minimal Rx lens manufacturing delays.

To illustrate, in some embodiments, an eyewear display manufacturer manufactures an eyewear display with the features described herein. The eyewear display includes an eyeglass frame form factor with a frame including two lens rims and a nose bridge. One lens rim (or both of the lens rims) holds a lens stack serving as an optical combiner. The lens stack includes a first lens (e.g., a world-side lens) and a waveguide. In some embodiments, the first lens rim also holds a placeholder lens. For example, the placeholder lens is a “blank” (i.e., does not include a vision correction prescription) lens on the eye-side of the waveguide. The first lens rim of the frame includes a detachable rim piece such as a detachable nose piece. In some embodiments, the detachable rim piece covers a loading cavity housing a lens retention component. After being detached from the lens rim, the detachable rim piece exposes the loading cavity and the lens retention component. The lens retention component, in some embodiments, is a retaining clip that fixes the placeholder lens in the first lens rim and is detachable from the loading cavity. Upon the lens retention component being detached from the loading cavity, the placeholder lens is removed from the first lens rim. Then, a second lens (such as an Rx lens) is inserted within the first lens rim into the volume previously occupied by the placeholder lens. Once the second lens is inserted into the first lens rim, the lens retention component is re-attached in the loading cavity to fix the second lens in the lens stack within the first lens rim. The detachable rim piece is then re-attached to the first lens rim to cover the loading cavity with the lens retention component arranged therein. In this manner, a party other than the eyewear display manufacturer is able to insert an Rx lens into the eyewear display. This reduces the burden of fulfilling all Rx lens types on the eyewear display manufacturer, thus enabling more users requiring Rx lenses to enjoy the AR experience.

To further illustrate, in some embodiments, the eyewear display includes a frame with a first lens rim to hold a lens stack serving as an optical combiner. The lens stack includes a first lens (e.g., a world-side lens) and a waveguide. In some embodiments, the first lens rim also holds a placeholder lens. In some embodiments, the frame includes a front frame component attached to a rear frame component forming a carrier cavity therebetween. The carrier cavity at least partially houses a first carrier within the cavity. The first carrier extends around the inner perimeter of the first lens rim. In some embodiments, a pressure sensitive adhesive (PSA) is applied to the first carrier, and the PSA is covered by a protective liner with a protective liner tab. The first lens rim of the frame includes a detachable rim piece such as a detachable nose piece. In some embodiments, the detachable rim piece covers a cavity in which the protective liner tab is positioned. After the detachable rim piece is detached from the first rim, the placeholder lens is removed from the first lens rim. Then, the protective liner tab is pulled to remove the protective liner covering the PSA, thereby exposing the PSA applied to the first carrier. Then, a second lens (such as an Rx lens) is inserted within the first lens rim into the volume previously occupied by the placeholder lens. In some embodiments, a PSA is applied around the perimeter of the second lens prior to insertion into the first lens rim. In this scenario, the PSA applied to the first carrier may be removed along with the protective liner. After being inserted and aligned within the first lens rim, the second lens is pressed to activate the PSA such that the second lens is adhered to the first carrier. Then, the detachable rim piece is re-attached to the first lens rim, thereby covering the cavity and securing the second lens into the first lens rim. In this manner, a party other than the eyewear display manufacturer is able to insert an Rx lens into the eyewear display. This reduces the burden of fulfilling all Rx lens types on the eyewear display manufacturer, thus enabling more users requiring Rx lenses to enjoy the AR experience.

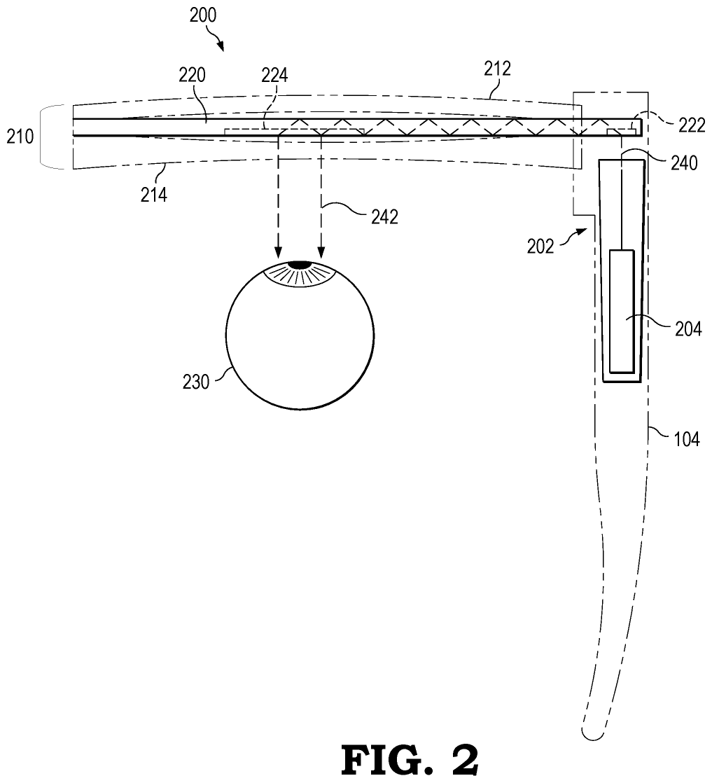

FIG. 1 illustrates an example eyewear display 100 in accordance with various embodiments. The eyewear display 100 (also referred to as a wearable heads up display (WHUD), head-mounted display (HMD), near-eye display, or the like) has a support structure, or frame, 102 that includes an arm 104 which houses a micro-display projection system configured to project images toward the eye of a user such that the user perceives the projected images as being displayed in a field of view (FOV) area 106 of a display at one or both of lens elements 108, 110 (only the FOV area 106 for lens element 110 is shown and labeled for clarity purposes). In the depicted embodiment, the frame 102 of the eyewear display 100 is configured to be worn on the head of a user and has a general shape and appearance (i.e., “form factor”) of an eyeglasses frame. The frame 102 contains or otherwise includes various components to facilitate the projection of such images toward the eye of the user, such as an image source (also referred to as light engine, optical engine, projector, or the like) and a waveguide (shown in FIG. 2, for example). In some embodiments, the frame 102 further includes various sensors, such as one or more front-facing cameras, rear-facing cameras, other light sensors, motion sensors, accelerometers, and the like. The frame 102 further can include one or more radio frequency (RF) interfaces or other wireless interfaces, such as a Bluetooth™ interface, a WiFi interface, and the like. The frame 102, in some embodiments, further includes processing circuitry or control circuitry to carry out functions of the eyewear display 100 such as eye tracking functions, for example. Further, in some embodiments, the frame 102 includes one or more batteries or other portable power sources for supplying power to the electrical components of the eyewear display 100. In some embodiments, some or all of these components of the eyewear display 100 are fully or partially contained within an inner volume of frame 102, such as within the arm 104 in a temple region 112 of the frame 102 or in a nose bridge 124 of the frame 102. It should be noted that while an example form factor is depicted, it will be appreciated that in other embodiments the eyewear display 100 may have a different shape and appearance from the eyeglasses frame depicted in FIG. 1.

As illustrated in FIG. 1, the eyewear display 100 includes two lens rims 120, 122 with a nose bridge 124 therebetween. In some embodiments, each lens rim includes a nose piece 126 that rests on the nose of a user when wearing the eyewear display 100. For example, lens rim 120 includes nose piece 126 and lens rim 122 also includes a corresponding nose piece (not labeled for clarity purposes). In some embodiments, the nose piece 126 is detachable from the lens rim 120 to expose a cavity, such as a loading cavity housing a lens retention component therein, to insert or replace an eye-side lens of the lens element 108, 110.

One or both of the lens elements 108, 110 are used by the eyewear display 100 to provide an AR or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays, and/or one or more prisms. In some embodiments, multiple image sources are included in the frame 102. In some cases, the multiple image sources are located in the temple region 112, in the nose bridge 124, or in a combination of the two (e.g., one image source in the temple region 112 and another image source in the nose bridge 124). One or both of the lens elements 108, 110 thus includes at least a portion of a waveguide that routes display light received by the multiple incouplers of the waveguide to the respective multiple outcouplers of the waveguide, which output the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, each of the lens elements 108, 110 includes a lens stack including a first lens and a second lens with the waveguide disposed therebetween. For example, in some embodiments, the first lens is a world-side lens (e.g., facing away from the user) and the second lens is an eye-side lens (e.g., facing toward the user). In some embodiments, the second lens is a vision correction prescription lens (or Rx lens) that accommodates the user's vision prescription. In some embodiments, the eyewear display 100 is designed to allow parties other than the manufacturer of the eyewear display 100 to remove and/or insert a second lens in the eyewear display. This allows for parties other than the eyewear display manufacturer to fulfill different Rx lens types for the eyewear display 100. For example, each lens rim 120, 122 of the eyewear display 100 includes a detachable nose piece (e.g., nose piece 126 on lens rim 120) that allows a third party access to replace or insert a second lens (i.e., an eye-side lens) into the eyewear display 100.

In some embodiments, each of the one or more image sources in the eyewear display 100 is a matrix-based projector, a scanning laser projector, or any combination of a modulative light source such as a laser or one or more LEDs and a dynamic reflector mechanism such as one or more dynamic scanners or digital light processors. In some embodiments, the image source includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The image source is communicatively coupled to a controller and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106, and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

FIG. 2 illustrates a portion of an eyewear display 200 in accordance with various embodiments. The eyewear display 200, for example, corresponds to the eyewear display 100 of FIG. 1.

As shown in FIG. 2, the eyewear display 200 includes an image projection system 202 with an image source 204 (also referred to as light engine, optical engine, projector, or the like). In some embodiments, the image projection system 202, including the image source 204, is included in the arm 104 of the eyewear display 200. The image projection system 202 emits display light 240 toward the incoupler 222 of a waveguide 220 that is integrated into lens 210.

The eyewear display 200 includes a lens 210 that serves as an optical combiner. In some embodiments, the lens 210 corresponds to one of lens elements 108, 110 of FIG. 1. In some embodiments, the lens 210 is held in one of the two lens rims (such as lens rim 120 or 122 of FIG. 1) of the eyewear display 200. The lens 210 includes a lens stack (or stack for short) including a first lens 212, a second lens 214, and a waveguide 220 disposed between the first lens 212 and the second lens 214. As illustrated, the first lens 212 is a world-side lens and the second lens 214 is an eye-side lens. In some embodiments, the waveguide 220 includes an incoupler 222 to incouple display light 240 into the waveguide 220 such that the display light is propagated within the waveguide 220 via various instances of total internal reflection (TIR). The waveguide 220 also includes an outcoupler 224 to outcouple the display light 242 toward an eye 230 of the user. Thus, the eyewear display 200 includes a lens 210 serving as an optical combiner that is held in place by a corresponding lens rim (e.g., such as one of lens rims 120, 122 of FIG. 1) of the eyewear display 200. Light exiting through the outcoupler 224 travels through the second lens 214. In use, the light exiting second lens 214 enters the pupil of an eye 230 of a user wearing the eyewear display 200, causing the user to perceive a displayed image carried by the light output by the optical engine 202. For example, the user perceives the displayed image over an FOV area such as FOV area 106 of FIG. 1. The different layers of the lens 210 are substantially transparent, such that light from real-world scenes corresponding to the environment around the eyewear display 200 passes through the first lens 212, the second lens 214, and the waveguide 220 to the eye 230 of the user. In this way, images or other graphical content output by the image projection system 200 are combined (e.g., overlayed) with real-world images of the user's environment when projected onto the eye 230 of the user to provide an AR experience to the user. Although not shown in the depicted example, in some embodiments additional optical elements are included in any of the optical paths between the optical engine 202 and the incoupler 214, in between the incoupler 214 and the outcoupler 216, and/or in between the outcoupler 216 and the eye 220 of the user (e.g., in order to shape the laser light for viewing by the eye 230 of the user).

In some embodiments, the second lens 214 is either a placeholder lens or an Rx lens that can be removed or inserted to the eyewear display 200 by parties or entities other than the manufacturer of eyewear display 200. For example, the eyewear display 200 includes second lens installment features that allow these other parties or entities (e.g., an optometrist) to install or replace the second lens 214 of the eyewear display 200. In some embodiments, the second lens installment features include one or more of a detachable rim piece, lens retention component, PSA, PSA liner, or the like.

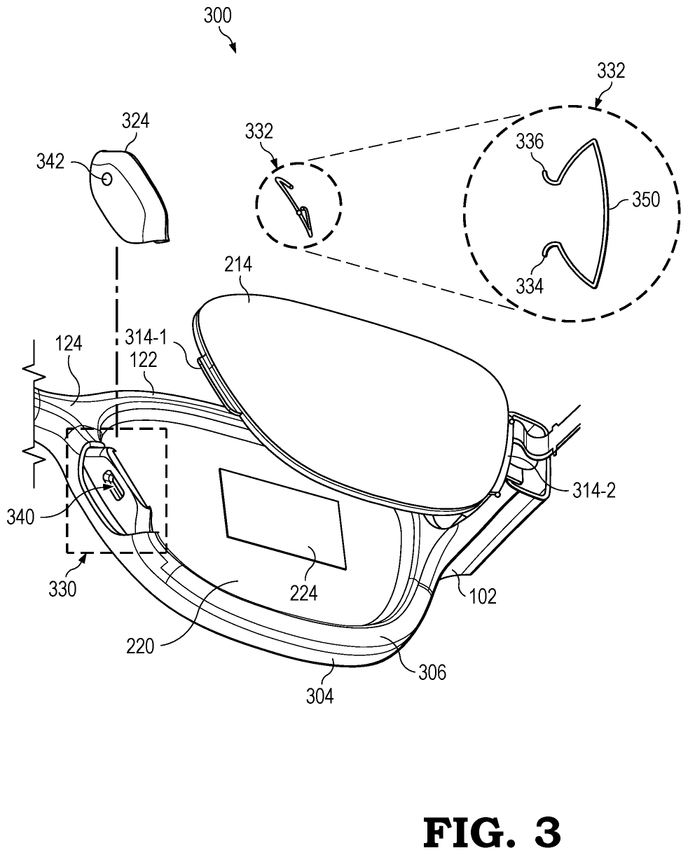

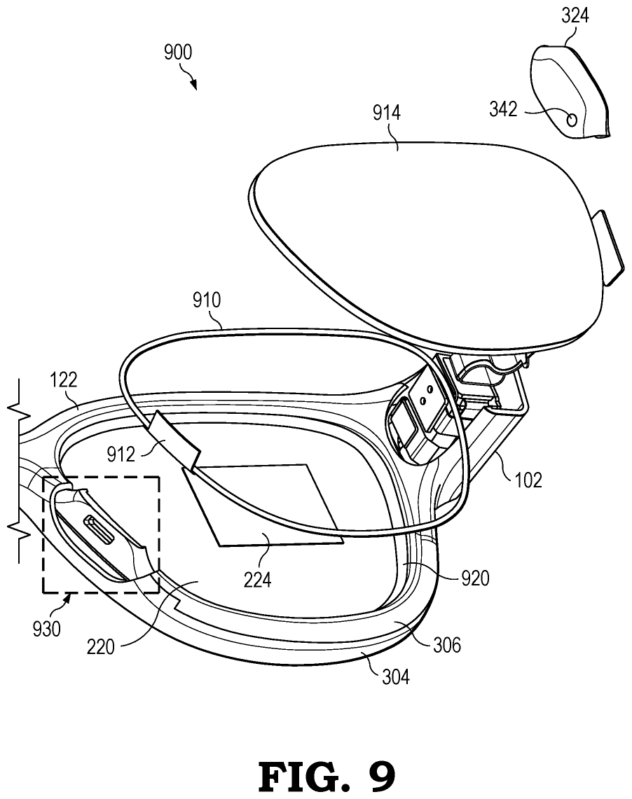

As described herein, FIGS. 3-8 cover mechanical embodiments for second lens installment features. That is, FIGS. 3-8 describe techniques to insert and fix a second lens, such as an Rx lens, in a lens rim of an eyewear display using mechanical components such as a lens retention component in the form of a retaining clip, for example. In some embodiments, the second lens installment techniques include adhesive-based embodiments. The adhesive-based embodiments for the second lens installment features are described in FIGS. 9-16. In some cases, the eyewear display includes second lens installment features including both the mechanical embodiments (e.g., those discussed in FIGS. 3-8) and the adhesive-based embodiments (e.g., those discussed in FIGS. 9-16). In other cases, the eyewear display includes second lens installment features for one of the two, i.e., the mechanical embodiments (e.g., those discussed in FIGS. 3-8) or the adhesive-based embodiments (e.g., those discussed in FIGS. 9-16).

FIG. 3 illustrates an exploded view of mechanical components for installing a second lens in an eyewear display 300 in accordance with various embodiments. In some embodiments, eyewear display 300 corresponds to eyewear display 100 or 200 shown in FIGS. 1 and 2, respectively.

In some embodiments, the frame 102 of the eyewear display 300 includes a front frame component 304 attached to a rear frame component 306. That is, the front frame component 304 is the part of the frame 102 that faces the world-side and the rear frame component 306 is the part of the frame 102 that faces the user. The lens rim 122 of the frame includes a detachable rim piece 324, that when attached to the frame 102, is positioned in the area marked by dashed line box 330. In the embodiment illustrated in FIG. 3, the detachable rim piece 324 is shown as a detachable nose piece. The nose piece is the part of the frame that sits on the user's nose to assist with fitting the eyewear display to the user's face and keep the eyewear display from slipping. In some embodiments, the nose piece is integrated directly into the lens rims. In other embodiments, the detachable rim piece 324 is positioned elsewhere around the lens rim 122 (e.g., near the temple region). When attached to the frame 102, the detachable nose piece 324 is positioned adjacent to or under the nose bridge 124. Furthermore, the detachable nose piece 324 covers a loading cavity 330 housing a lens retention component 332. In FIG. 3, the lens retention component 332 is illustrated as a retaining clip with two ends 334, 336 and a bridge portion 350 between the two ends 334, 336. In some embodiments, the retaining clip is made of a metal or other similar material that is capable of elastic deformation when a force is applied to it. For example, the retaining clip is made of a wire-like metal or molded plastic with dimensions that are influenced by the interfacial features (e.g., the gap between the second lens and the lens rim). In some embodiments, the interfacial features to insert and remove the second lens range from 3 mm to 5 mm long and 1 mm to 2 mm wide. Thus, the retaining clip 332, in some embodiments, has a width of approximately 40 mm to 70 mm, a height of 30 mm to 60 mm, and a material thickness of about 0.2 to 0.6 mm thick. In some embodiments, the retaining clip is fixed in the loading cavity shown in area 330 by placing both of its ends 334, 336 in hole 340. For example, both ends 334, 336 of the retaining clip are pressed together to elastically deform the retaining clip into a compressed state. Then, the ends 334, 336 are inserted into the hole 340, and when the applied force is released, both ends 334, 336 of the retaining clip 332 return to the relaxed, or non-compressed, state and press against the sides of the hole 340 to fix the retaining clip 332 in the hole 340. After the retaining clip 332 is fixed in the loading cavity 330, the detachable nose piece 324 is re-attached to the lens rim 122 to cover up the loading cavity and the retaining clip 332.

In some embodiments, the detachable nose piece 324 and the retaining clip 332 can be removed and re-attached in order to insert a second lens 214. For example, the second lens 214 is an Rx lens that can be manufactured at an optometrist to fulfill a user's vision correction prescription and inserted into the eyewear display 200. The process to insert the second lens 214 into the eyewear display 300 is as follows. First, the detachable nose piece 324 is removed. For example, the detachable nose piece 324 includes a locking mechanism such as a protrusion or hook that fits into or latches onto a notch or pin in the lens rim 122. The detachable rim piece 324, in some embodiments, includes a hole 342 in which a tool (e.g., a pin or other needle-pointed object) may be inserted to detach the detachable rim piece 324 from the lens rim 122. Removing the detachable rim piece 324 exposes the loading cavity 330 in the lens rim 122. The retaining clip 334 is locked into the hole 340 in the loading cavity. For example, the ends 334, 336 of the retaining clip 332 are positioned against the inner sides of the hole 340. When the ends 334, 336 are compressed together (e.g., by pressing them together with a tool or by hand), the retaining clip 332 is removed from the loading cavity to remove the placeholder lens and/or insert a second lens such as an Rx lens. In cases where a placeholder lens is included in the eyewear display, the removal of the retaining clip 332 allows for the placeholder lens to be removed. Then, the second lens 214 is inserted into the lens rim 122. For example, the second lens 214 is inserted into the volume previously occupied by the placeholder lens. That is, the second lens 214 is positioned into the lens rim 122 so that it is arranged on the eye-side of the waveguide 220. In some embodiments, the second lens 214 includes one or more tabs 314-1, 314-2. Each of the tabs of the second lens 214 is inserted into a corresponding cavity (not illustrated in FIG. 3) around the lens rim 122 such that the second lens is properly aligned in the lens rim 122. After the second lens 214 is positioned in the lens rim 122, the retaining clip 332 is re-inserted into the hole 340 to lock the second lens 214 into place. For example, the ends 332, 334 of retaining clip are compressed together and placed in the hole 340 and the portion 350 of the retaining clip between the two ends 332, 334 is positioned into a space between the lens rim 122 and the second lens. Once the compressing force is released, the retaining clip 332 returns back to its non-compressed state (or relaxed state), thereby pressing against the side of the second lens 214 to lock it into place in the lens rim. Then, the detachable nose piece 324 is re-attached to the lens rim 122 to complete the assembly process. In this manner, a second lens 214 (e.g., an Rx lens) can be inserted into the eyewear display 300 by a party other than the manufacturer of the eyewear display 300.

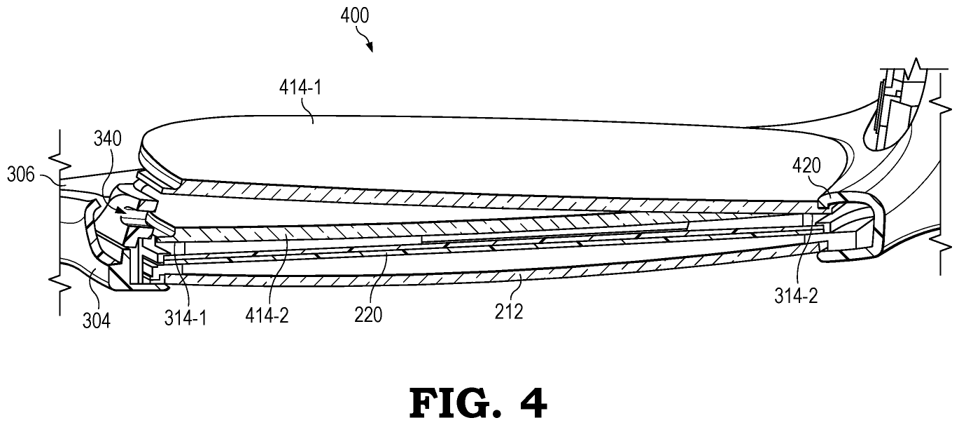

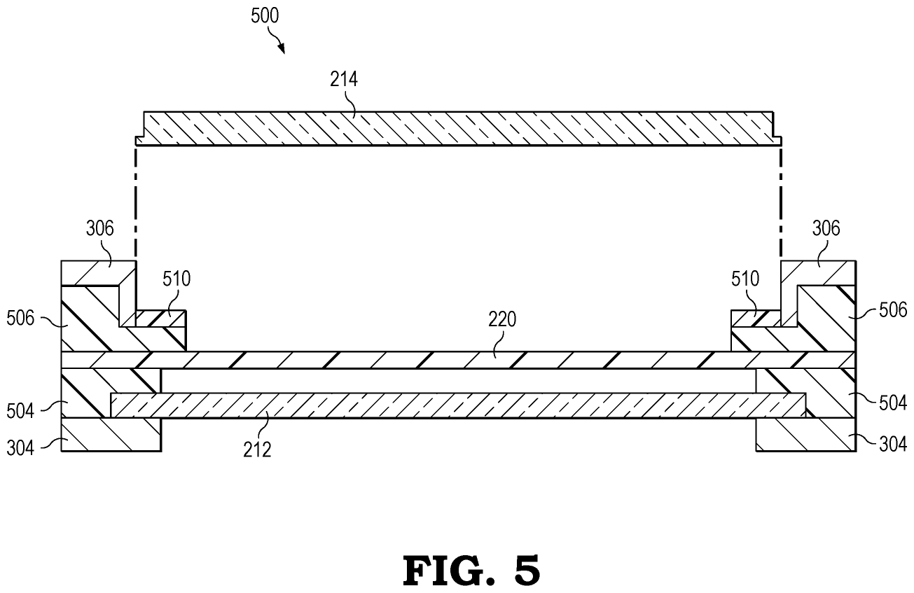

FIG. 4 shows a diagram illustrating a perspective view of two stages 414-1, 414-2 of the second lens 214 insertion process into the eyewear display 300 in accordance with various embodiments. At the first stage, the second lens 214 is positioned at 414-1. As shown at second lens position 414-1, tab 314-2 of the second lens 214 is initially positioned under notch 420 on the rear frame component 306. After the second tab 314-2 is secured in the lens rim 122 under notch 420, the second lens 214 is pressed down into position 414-2 such that tab 314-1 rests within the lens rim below the hole 340. For example, the tab 314-1 is positioned to rest on a silicon seal on the eye-side carrier (illustrated in FIG. 5). In this manner, once the retaining clip is inserted into the hole 340, the retaining clip presses against tab 314-1 to lock the second lens 214 into the lens rim.

FIG. 5 shows a cross-sectional view of a lens rim 500, such as one of lens rims 120, 122 of FIGS. 1-3, in accordance with various embodiments. As shown in FIG. 5, the second lens 214 is illustrated as being separated from the other components since it can be removed and re-inserted into the lens rim 500 based on the techniques described herein.

The outer components of the lens rim 500 correspond to the frame of the eyewear display and include the front frame component 304 and the rear frame component 306. A world-side carrier 504 is positioned adjacent to the front frame component 304 and an eye-side carrier 506 is positioned adjacent to the rear frame component 306. The first lens 212 is positioned between the world-side carrier 504 and the front frame component 304. The waveguide 220 is positioned between the world-side carrier 504 and the eye-side carrier 506. A sealing ring 510 (e.g., made of a silicon) is applied to the eye-side carrier 506. When inserted into the lens rim 500, the second lens 214 is positioned to rest on the sealing ring 510. Then, when the lens retention component (not pictured) is re-inserted, the contact formed between the sealing ring 510 and the second lens 214 provides IP sealing for the eyewear display.

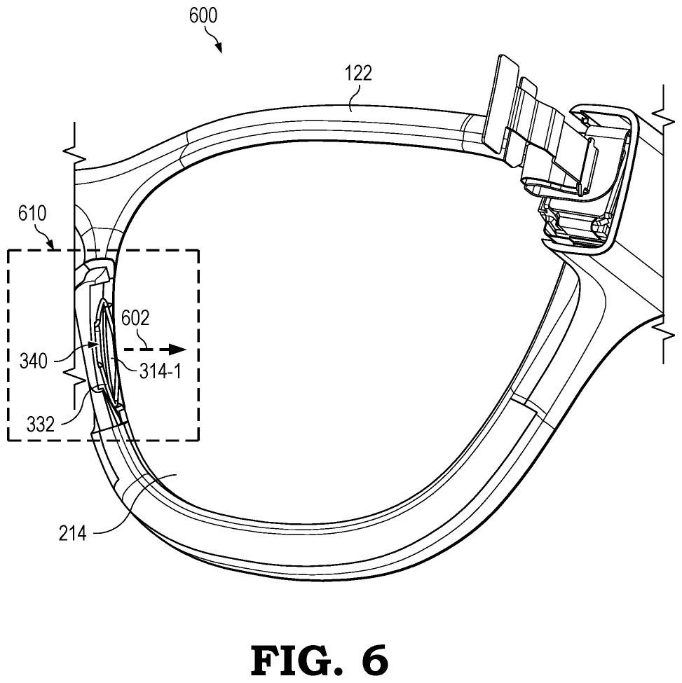

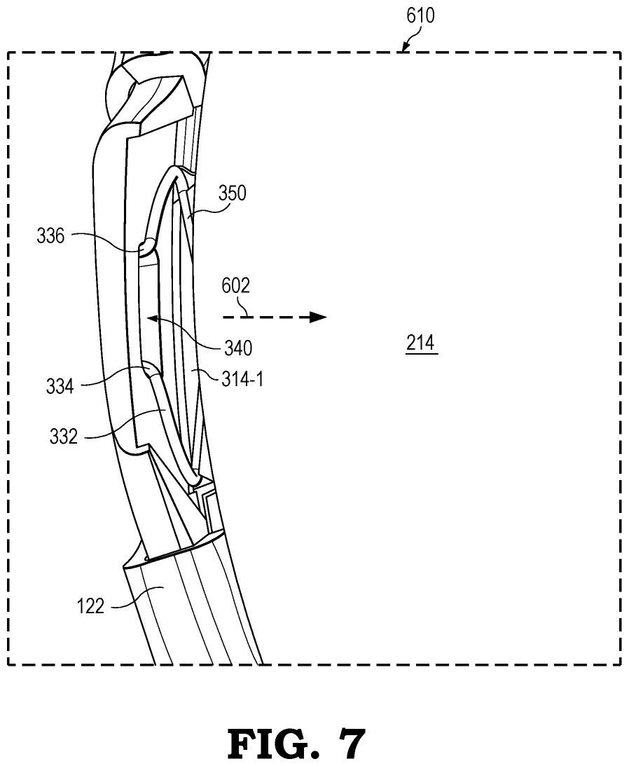

FIG. 6 illustrates a perspective view 600 of a lens rim 122 after the insertion of the second lens 214 and the retaining clip 332 into the hole 340 and prior to the re-attachment of the detachable nose piece. As shown in FIG. 6, the retaining clip 332 is inserted into the hole 340 to lock the second lens 214 into the lens rim 122. For example, the retaining clip 332 locks the second lens 214 by locking the first tab 314-1 of the second lens 214 under the retaining clip 332 to ensure the second lens 214 is properly seated within the lens rim 122, and/or by exerting an elastic deformation force (shown by dashed line arrow 602) to press the second lens 214 against the inner perimeter of the lens rim 122 so that the second lens 214 is properly aligned within the lens rim 122. FIG. 7 shows a close-up view of dashed line box 610 of FIG. 6. As shown in FIG. 7, the two ends 334, 336 of the retaining clip 332 are placed into the hole 340 and lock the retaining clip 332 in the hole 340 by pressing against the sides of the hole 340. Additionally, portion 350 of the retaining clip 332 is pressed against the second lens 214 and exerts force 602 to lock the second lens 214 into the lens rim 122.

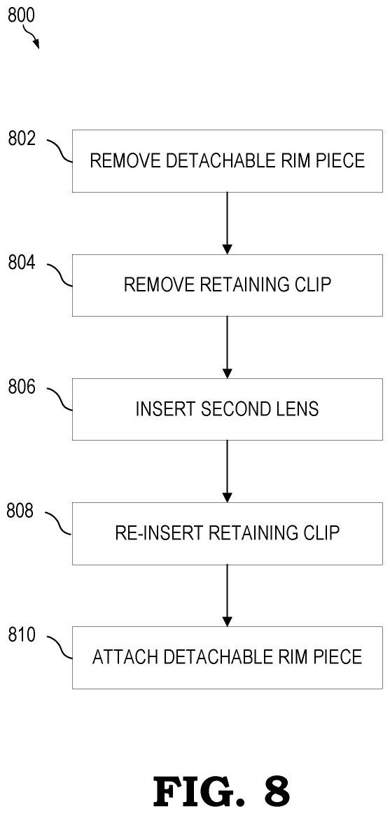

FIG. 8 illustrates a flowchart 800 detailing a method to insert a second lens (e.g., an Rx lens) into an eyewear display, such as eyewear display 100, in accordance with various embodiments. In some embodiments, the eyewear display is manufactured with second lens installment features such as those described herein to enable a party other than the manufacturer of the eyewear display to insert an Rx lens in the eyewear display.

At 802, the method includes removing a detachable rim piece. For example, this includes removing a detachable nose piece from a lens rim of an eyewear display as described above with respect to FIGS. 3-7 to expose a loading cavity (e.g., loading cavity 330). At 804, the method includes removing a retaining clip from the loading cavity. For example, this includes removing retaining clip 332 as described above with respect to FIGS. 3-7. In embodiments where a placeholder lens is included in the eyewear display, after the retaining clip is removed, the placeholder lens is also removed from the eyewear display. In some cases, the placeholder lens is included in the lens rim of the eyewear display to protect other components of the eyewear display (e.g., to provide a protective cover for the waveguide). At 806, the method includes inserting the second lens into the lens rim of the eyewear display. For example, inserting the second lens into the lens rim as described above with respect to FIGS. 3-7. In some embodiments, the second lens is an Rx lens that is fulfilled by an optometrist or other Rx lens provider. At 808, the method includes re-inserting the retaining clip into the loading cavity to fix the second lens into the lens rim. For example, this includes attaching retaining clip 332 into hole 340 of the loading cavity as described above with respect to FIGS. 3-7. At 810, the method includes re-attaching the detachable rim piece to the lens rim to cover up the loading cavity and the retaining clip.

FIG. 9 illustrates an exploded view of adhesive-based components for installing a second lens in an eyewear display 900 in accordance with various embodiments. In some embodiments, eyewear display 900 corresponds to eyewear display 100 or 200 shown in FIGS. 1 and 2, respectively. Furthermore, in some embodiments, eyewear display 900 shares common features with eyewear display 300 of FIG. 3, e.g., frame 102, lens rim 122, waveguide 220, outcoupler 224, front frame component 304, rear frame component 306, and detachable rim piece 324 (with an optional hole 342 to facilitate the removal of the detachable rim piece from the lens rim 122). In some embodiments, FIG. 9 shows the components of the eyewear display 900 at an initial stage prior to insertion of an Rx lens.

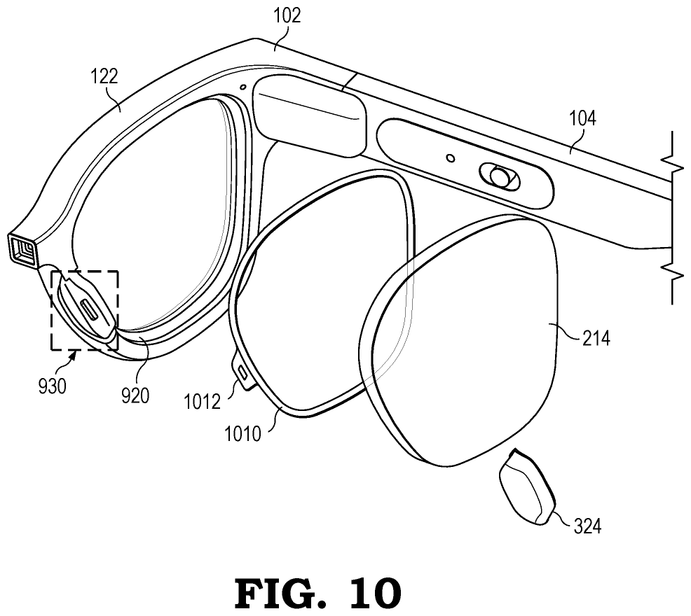

In some embodiments, the frame 102 of the eyewear display 900 includes a front frame component 304 attached to a rear frame component 306. That is, the front frame component 304 is the part of the frame 102 that faces the world-side and the rear frame component 306 is the part of the frame 102 that faces the user. In some embodiments, the front frame component 304 and the rear frame component 306 form a cavity therebetween. For example, two carriers may be arranged in the cavity and extend around the perimeter of the lens rim 122. The first carrier 920 is an eye-side carrier and the second carrier is a world-side carrier (not shown). In some embodiments, a portion of a first carrier 920 protrudes from around the inner perimeter of the lens rim 122. In some embodiments, the waveguide 220 is arranged between the first carrier 920 and the second carrier. The lens rim 122 of the frame includes a detachable rim piece 324, that when attached to the frame 102, is positioned in the loading cavity 930. In the embodiment illustrated in FIG. 9, the detachable rim piece 324 is shown as a detachable nose piece. This is a matter of design choice and the detachable rim piece 324 may be positioned elsewhere around the lens rim 122 (e.g., near the temple region). When attached to the frame 102, the detachable nose piece 324 is positioned adjacent to or under the nose bridge of the eyewear display. Furthermore, the detachable nose piece 324 covers a loading cavity 930. When the detachable nose piece 324 is detached from the eyewear display, the placeholder lens 914 is removable from the lens rim 122 to expose a protective liner tab 912 of the protective liner 910. The protective liner 910 is situated on the first carrier 920 around the inner perimeter of the lens rim 122 and covers a pressure-sensitive adhesive (PSA) that is placed on the first carrier 920. The placeholder lens 914 is thus situated on top of the protective liner 910 and offers a protective cover to the waveguide 220. The placeholder lens 914 can be removed from the lens rim 122 of the eyewear display 900 according to the following process. First, the detachable rim piece 324 (in this case, a detachable nose piece 324) is removed from the lens rim 122. Then, the placeholder lens 914 is removed. That is, because the protective liner 910 covers the PSA arranged on the first carrier 920, the placeholder lens 914 is not adhered to the eyewear display. After the placeholder lens 914 is removed, the protective liner tab 912 is pulled to remove the protective liner 910 from the PSA applied to the first carrier 920. That is, removing the protective liner 910 exposes a PSA on the first carrier 920. Then, a second lens is insertable into the lens rim 122 and the eyewear display 900 can be reassembled (shown in FIG. 10).

FIG. 10 shows an exploded view of an eyewear display 1000 after the second lens 214 is inserted on the PSA 1010 applied to the first carrier 920. That is, eyewear display 1000 corresponds to eyewear display 900 after the placeholder lens 914 and the protective liner 910 are removed and the second lens 214 (such as an Rx lens) is inserted into the eyewear display. In some embodiments, the PSA 1010 also include a PSA tab 1012 positioned in cavity 930 to facilitate the removal of the PSA 1010 and second lens 214 in situations where the second lens 214 needs to be replaced (e.g., due to damage to the second lens 214 or a change in the user's vision prescription). After the second lens 214 is placed on the PSA 1010, it is pressed down to activate the PSA 1010 to adhere the outer perimeter of the second lens 214 to the first carrier 920. Then, the detachable nose piece 324 is re-attached to the lens rim 122 to cover loading cavity 930. In some embodiments, the PSA 1010 is one of the following types of PSA: a bond and detach adhesive, a cuttable foam adhesive, a foam with support adhesive, a reworkable very high bonding tape (VHB), a stretchable polyurethane (PU) adhesive, or the like. In addition to adhering the second lens 214 to the first carrier 920 in the lens rim 122, the PSA 1010 functions as an IP sealant for the eyewear display. Then, the detachable noise piece 324 is reattached over loading cavity 930. In this manner, a second lens 214 (e.g., an Rx lens) can be inserted into the eyewear display by a party other than the manufacturer of the eyewear display.

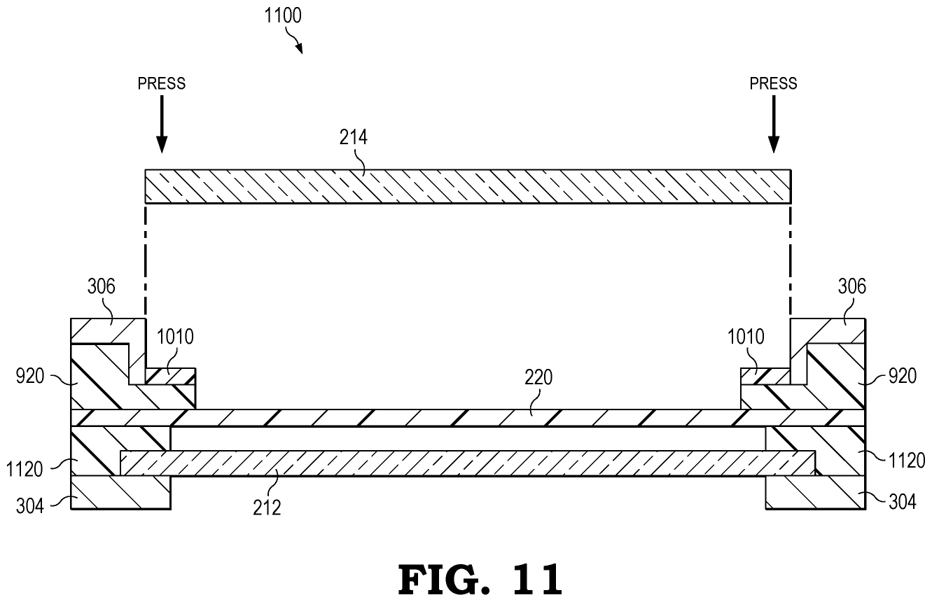

FIG. 11 shows a cross-sectional view of a lens rim 1100, such as one of lens rims 120, 122 of FIGS. 1-3, 9, and 10, in accordance with various embodiments. As shown in FIG. 11, the second lens 214 is illustrated as being separated from the other components since it can be removed and re-inserted into the lens rim 1100 based on the techniques described herein.

The outer components of the lens rim 1100 correspond to the frame of the eyewear display and include the front frame component 304 and the rear frame component 306. A second carrier 1120 (e.g., a world-side carrier) is positioned adjacent to the front frame component 304 and the first carrier 920 (e.g., an eye-side carrier) is positioned adjacent to the rear frame component 306. The first lens 212 is positioned between the second carrier 1120 and the front frame component 304. The waveguide 220 is positioned between the second carrier 1120 and the first carrier 920. The PSA 1010 is applied to the first carrier 920. When inserted into the lens rim 1100, the second lens 214 is positioned to rest on the PSA 1010 applied to the first carrier 920. Then, when the second lens 214 is pressed (indicated by arrows labeled PRESS) into the PSA 1010, it activates the PSA 1010 so that the second lens 214 attaches to the first carrier 920 within the lens rim 1100. In some embodiments, the PRESS force to the second lens 214 is in the range of 10-50 pounds per square inch (PSI) to activate the PSA 1010 (i.e., to adhere the second lens 214 to the first carrier 920 via the PSA 1010).

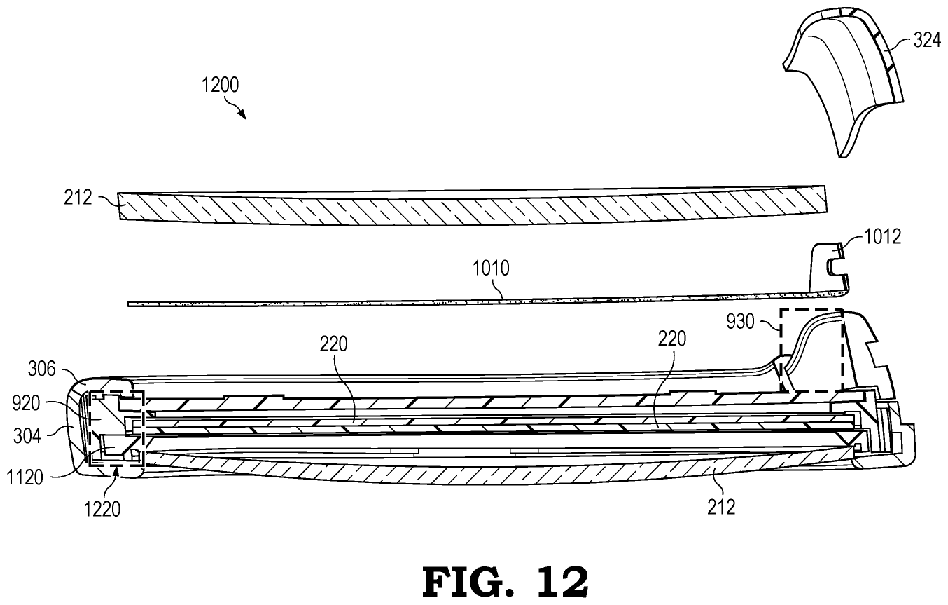

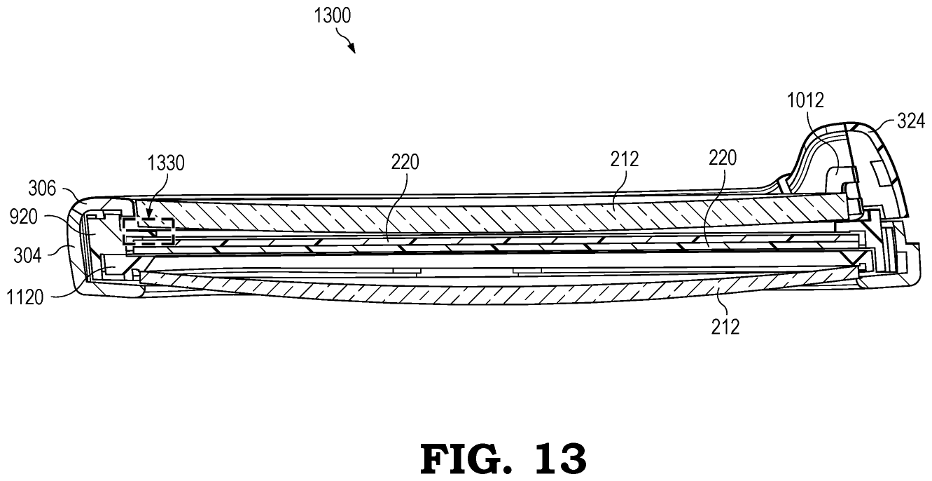

FIG. 12 shows a semi-exploded side view 1200 of a lens rim 1200 of an eyewear display with the second lens 214 (such as an Rx lens) inserted into the eyewear display. FIG. 13 shows the un-exploded side view. In some embodiments, lens rims 1200, 1300 correspond to lens rim 120, 122 shown in the previous figures.

As shown in FIG. 12, the lens rim 1200 includes a front frame component 304 attached to a rear frame component 306 forming a cavity 1220 therebetween. The first carrier 920 and the second carrier 1120 are positioned in the cavity and serve as the support structures for the lens stack in the lens rim 1200. The lens stack includes a first lens 212 on the world-side that is positioned between the front frame component 304 and the second carrier 1120, a waveguide 220 positioned between the first carrier 920 and the second carrier 1120, and the second lens 212, which when inserted into the lens rim (as depicted in lens rim 1300 in FIG. 13) is positioned between the first carrier 920 and the rear frame component 306. The second lens 212 is adhered to the first carrier 920 via PSA 1010 that is arranged on portion of the first carrier that protrudes inside an inner perimeter of the lens rim. Box 1330 in FIG. 13 illustrates one such section of this protruding portion.

Once assembled, the second lens 212 is adhered to the first carrier 920 via the PSA 1010. The PSA tab 1012 is arranged in cavity 920 under the detachable nose piece 324. Afterwards, the second lens 212 may be replaced (e.g., the second lens is damaged, or the user's vision correction prescription has changed), by the following process. First, the detachable nose piece 324 is detached. Then, the PSA tab 1012 is pulled to disengage the PSA 1010 from the first carrier, 920, thereby also detaching the second lens 212 from the first carrier 920. Afterwards, a new PSA 1010 is applied to the first carrier 920 around the lens rim, and a new second lens 212 may be inserted into the eyewear display. Thus, parties other than the eyewear display manufacturer can insert or replace the second lens with a vision correction prescription into the eyewear display.

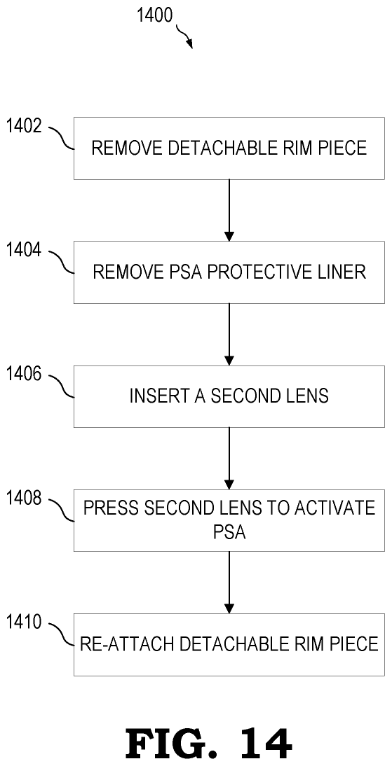

FIG. 14 illustrates a flowchart 1400 detailing a method to insert a second lens (e.g., an Rx lens) into an eyewear display, such as eyewear display 100, in accordance with various embodiments. In some embodiments, the eyewear display is manufactured with second lens installment features such as those described herein to enable a party other than the manufacturer of the eyewear display to insert an Rx lens in the eyewear display.

At 1402, the method includes removing a detachable rim piece. For example, this includes removing a detachable nose piece from a lens rim of an eyewear display as described above with respect to FIGS. 9-10 and 12-13 to expose a loading cavity (e.g., loading cavity 930). In situations where a placeholder lens (e.g., placeholder lens 914) is included in the eyewear display, the placeholder lens is removed from the lens rim after detaching the detachable rim piece. At 1404, the method includes removing the PSA protective liner. For example, this includes pulling on a protective liner tab (such as protective liner tab 912) that is positioned in the loading cavity to remove the protective liner to expose the PSA applied on the first carrier around the inner perimeter of the lens rim. At 1406, the second lens is inserted into the lens rim. For example, inserting the second lens into the lens rim as described above with respect to FIGS. 10-13. In some embodiments, this includes aligning the second lens with the lens rim so that it is properly positioned within the lens rim. In some embodiments, the second lens is an Rx lens that is provided by an optometrist or other Rx lens provider. Once the second lens is inserted and properly aligned in the lens rim, the second lens is pressed to activate the PSA 1408. For example, this includes applying a force of about 10-50 PSI at one or more points along the perimeter of the second lens to adhere the second lens to the first carrier via the PSA. At 1410, the method includes re-attaching the detachable rim piece to the lens rim to cover up the loading cavity and a PSA tab (such as PSA tab 1012).

In some embodiments, the method of flowchart 1400 includes the optional feature that a PSA is applied around the perimeter of the second lens prior to inserting the second lens at block 1406. That is, in some cases, along with removing the protective liner at block 1404, the PSA on the first carrier is also removed. Then, the second lens with the PSA applied to it, is inserted into the lens rim at block 1406 and pressed to activate the PSA applied to the second lens at block 1408.

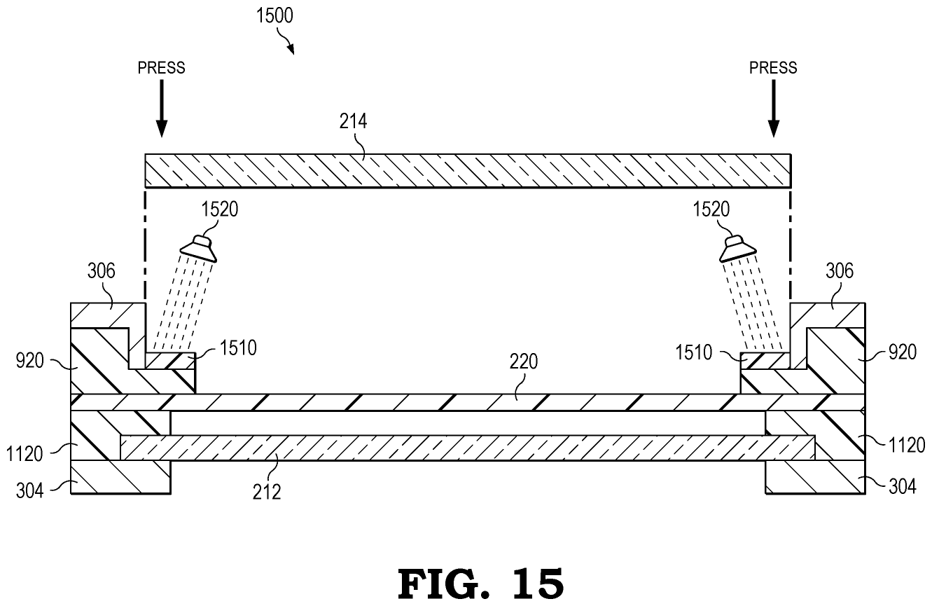

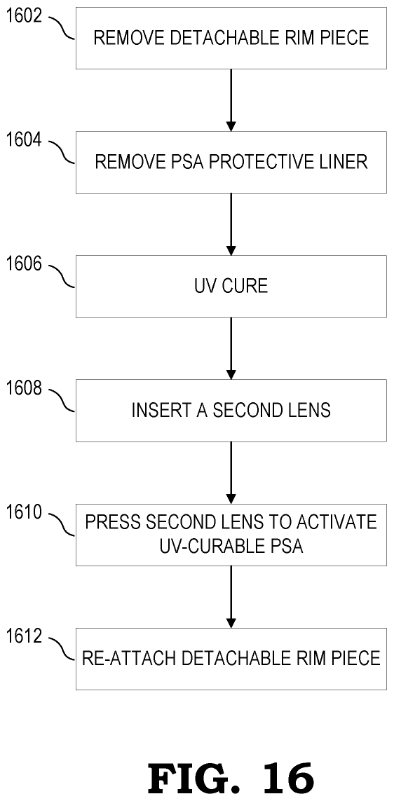

In some embodiments, the PSA is an ultraviolet (UV) curable PSA. For example, in some scenarios, a UV-curable PSA is used to increase the bonding strength of the second lens to the first carrier and/or to decrease the likelihood of premature activation of the PSA to the PSA liner or placeholder lens. FIGS. 15 and 16 describe the additional steps for inserting the second lens if a UV-curable PSA is used. In some embodiments, the features discussed in FIGS. 15 and 16 are similar to or overlap with the features described in FIGS. 9-14 with the additional feature of UV-activating the UV-curable PSA prior to inserting the second lens into the lens rim. In some embodiments, the UV-curable PSA is a UV-curable acrylic, UV-curable epoxy, UV-curable polyurethane, UV-curable polyester, UV-curable silicone, or the like.

FIG. 15 shows a similar cross-sectional view of a lens rim 1500 as illustrated in FIG. 11 with the exception that the PSA 1010 in FIG. 11 has been replaced with a UV-curable PSA 1510. Thus, after removing the placeholder lens (such as placeholder lens 914) and/or PSA protective liner (such as PSA protective liner 910 with liner tab 912) to expose the UV-curable PSA 1510, the UV-curable PSA 1510 is exposed to UV light 1520 to activate the UV-curable PSA 1510. Then, the second lens 214 is inserted into the lens rim to rest on the cured UV-curable PSA 1510 on the first carrier 920. After insertion and alignment in the lens rim, the second lens 214 is pressed (indicated by arrows labeled PRESS) into the cured UV-curable PSA 1510 to attach it to the first carrier 920 within the lens rim 1500. In some embodiments, the PRESS force to the second lens 214 is in the range of 10-50 pounds per square inch (PSI).

FIG. 16 illustrates a flowchart 1600 detailing a method to insert a second lens (e.g., an Rx lens) into an eyewear display, such as eyewear display 100, in accordance with various embodiments. In some embodiments, the eyewear display is manufactured with second lens installment features such as those described herein to enable a party other than the manufacturer of the eyewear display to insert an Rx lens in the eyewear display.

At 1602, the method includes removing a detachable rim piece. For example, this includes removing a detachable nose piece from a lens rim of an eyewear display as described above with respect to FIGS. 9-10 and 12-13 to expose a loading cavity (e.g., loading cavity 930). In situations where a placeholder lens (e.g., placeholder lens 914) is included in the eyewear display, the placeholder lens is removed from the lens rim after detaching the detachable rim piece. At 1604, the method includes removing the PSA protective liner. For example, this includes pulling on a protective liner tab (such as protective liner tab 912) that is positioned in the loading cavity to remove the protective liner to expose the UV-curable PSA applied on the first carrier around the inner perimeter of the lens rim. At 1606, the method includes UV curing the UV-curable PSA. For example, this includes exposing the UV-curable PSA for a specified duration of time to activate the UV-curable PSA.

At 1608, the second lens is inserted into the lens rim. For example, inserting the second lens into the lens rim as described above with respect to FIGS. 10-13 and 15. In some embodiments, this includes aligning the second lens with the lens rim so that it is properly positioned within the lens rim. In some embodiments, the second lens is an Rx lens that is provided by an optometrist or other Rx lens provider. Once the second lens is inserted and properly aligned in the lens rim, the second lens is pressed into the UV-curable PSA 1610. For example, this includes applying a force of about 10-50 PSI at one or more points along the perimeter of the second lens to adhere the second lens to the first carrier via the UV-curable PSA. At 1612, the method includes re-attaching the detachable rim piece to the lens rim to cover up the loading cavity and a PSA tab on the UV-curable PSA (similar to PSA tab 1012 on PSA 1010).

In some embodiments, the method of flowchart 1600 includes the optional feature that the UV-curable PSA is applied around the perimeter of the second lens. That is, at block 1604, along with removing the protective liner 1602, the PSA applied to the first carrier is also removed. Then, the UV-curable PSA is applied around the perimeter of the second lens and cured at 1606 prior to inserting the second lens at block 1608. Then, the second lens with the UV-cured PSA around its perimeter is pressed to activate the PSA applied to the second lens at block 1610.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display comprising:
a frame comprising two lens rims and a nose bridge, at least a first lens rim of the two lens rims to hold a stack comprising a first lens and a waveguide;
a detachable rim piece attached to the first lens rim, the detachable rim piece covering a loading cavity housing a lens retention component; and
the lens retention component to fix a second lens within the first lens rim when the lens retention component is secured to the first lens rim within the loading cavity.

2. The eyewear display of claim 1, wherein the second lens comprises a curvature corresponding to a vision correction prescription.

3. The eyewear display of claim 1, the lens retention component to fix the second lens on an opposite side of the waveguide as the first lens, wherein the first lens is a world-side lens and the second lens is an eye-side lens.

4. The eyewear display of claim 1, wherein the detachable rim piece is a detachable nose piece adjacent to the nose bridge.

5. The eyewear display of claim 1, wherein the loading cavity comprises a hole in the first lens rim.

6. The eyewear display of claim 5, wherein the lens retention component comprises a retaining clip.

7. The eyewear display of claim 6, wherein the retaining clip comprises two ends, which when placed in the hole, lock the retaining clip in the loading cavity.

8. The eyewear display of claim 7, wherein the retaining clip is configured to fix the second lens within the first lens rim by applying a force to the second lens, the force caused by an elastic deformation of the retaining clip.

9. The eyewear display of claim 1, further comprising a seal applied around an inner perimeter of the first lens rim.

10. The eyewear display of claim 1, wherein the frame comprises a front frame component and a rear frame component attached to one another forming a carrier cavity, wherein a world-side carrier and an eye-side carrier are at least partially housed within the carrier cavity, wherein the waveguide is positioned between the eye-side carrier and the world-side carrier and the first lens is positioned on an opposite side of the world-side carrier as the waveguide.

11. A method comprising:
removing a detachable rim piece from at least one lens rim of two lens rims of an eyewear display to expose a loading cavity, wherein the at least one lens rim holds a stack comprising a first lens and a waveguide;
inserting a second lens within the at least one lens rim, wherein the second lens comprises a curvature corresponding to a vision correction prescription;
positioning a lens retention component in the loading cavity to secure the second lens within the at least one lens rim; and
re-attaching the detachable rim piece to the at least one lens rim over the lens retention component to cover the loading cavity.

12. The method of claim 11, further comprising, after removing the detachable rim piece, removing the lens retention component from the loading cavity.

13. The method of claim 12, further comprising, after removing the lens retention component from the loading cavity, removing a placeholder lens prior to inserting the second lens within the at least one lens rim.

14. The method of claim 12, wherein the lens retention component is a retaining clip, wherein the positioning the lens retention component in the loading cavity to secure the second lens within the at least one lens rim comprises placing two ends of the retaining clip in an opening in the loading cavity to lock the second lens in the at least one lens rim.

15. The method of claim 11, further comprising performing the method at a second lens rim of the two lens rims to secure an additional second lens in the second lens rim, the additional second lens comprising a curvature corresponding to a vision correction prescription.

16. An eyewear display comprising:
a frame comprising two lens rims and a nose bridge, at least a first lens rim of the two lens rims to hold a stack comprising a first lens and a waveguide, wherein the frame comprises a front frame component and a rear frame component attached to one another forming a carrier cavity, wherein a first carrier is at least partially housed within the carrier cavity around the at least first lens rim;
a pressure sensitive adhesive (PSA) applied to the first carrier, the PSA covered by a protective liner comprising a protective liner tab; and
a detachable rim piece attached to the first lens rim, the detachable rim piece covering a cavity in which the protective liner tab is positioned.

17. The eyewear display of claim 16, wherein the PSA is an ultraviolet (UC) curable PSA.

18. The eyewear display of claim 16, further comprising a placeholder lens positioned adjacent to the protective liner in the first lens rim.

19. A method comprising:
removing a detachable rim piece from at least one lens rim of an eyewear display to expose a protective liner tab, wherein the at least one lens rim holds a lens stack comprising a first lens and a waveguide;
removing a protective liner by pulling on the protective liner tab to expose a pressure sensitive adhesive (PSA) layer applied to a first carrier around an inner perimeter of the at least one lens rim;
inserting a second lens into the at least one lens rim and pressing the second lens into the PSA layer to adhere the second lens to the first carrier, wherein the second lens comprises a curvature corresponding to a vision correction prescription; and
re-attaching the detachable rim piece to the at least one lens rim over the second lens.

20. The method of claim 19, wherein the PSA layer is an ultraviolet (UV) curable PSA layer, the method further comprising:
prior to inserting the second lens into the at least one lens rim and pressing the second lens into the PSA layer to adhere the second lens to the first carrier, curing the UV curable PSA layer under UV light for a specified duration.
